(19) United States
(12) Patent Application Publication
(10) Pub. No.: US 2004/0006701 A1
(43) Pub. Date: Jan. 8, 2004

(54) Method and apparatus for authentication of recorded audio

(75) Inventors: Roman Kresina, Oxford, CT (US); Michael Landino, Orange, CT (US)

Correspondence Address: OPPEDAHL AND LARSON LLP, P O BOX 5068, DILLON, CO, 80435-5068, US

(73) Assignee: ADVANCED DECISIONS INC., Shelton, CT (US)

(21) Appl. No.: 10/249,408

(22) Filed: Apr. 7, 2003

Related U.S. Application Data
(60) Provisional application No. 60/372,630, filed on Apr. 13, 2002.

(51) Int. Cl. H04L 9/00

(52) U.S. Cl. 713/189; 713/181; 713/176; 713/175

(57) ABSTRACT

A set of procedures is described which permit signing digital audio recordings by means of private keys, and which permit later authentication of such recordings, for example in a courtroom, in a way that is well suited to comprehension by non-technical personnel. Importantly, the explanation leading to such comprehension does not enable the creation of tampered recordings that would appear to be authentic. The procedures call for signing by trusted and disinterested third parties and for distributing hardware tokens storing various keys and key pairs. The format of the digital audio recordings permits playback on conventional equipment and also on equipment having cryptographic capabilities for authentication.

### CROSS REFERENCE TO RELATED APPLICATIONS

This application claims the benefit of U.S. appl. No. 60/372,630 filed Apr. 13, 2002, which application is hereby incorporated herein by reference for all purposes.

### BACKGROUND OF INVENTION

Establishing the authenticity of evidence for legal proceedings is often a cumbersome and time-consuming process. In the case of tangible evidence (e.g. a gun or item of clothing or a trace of a bodily fluid) it is necessary to establish and preserve a “chain of custody” for the evidence. Each step along the way from collection of the evidence to the proffer of evidence in a courtroom must be attested to by a witness, typically a police officer, a detective, a crime scene investigator, or a laboratory technician. The span of time between collection to proffer generally includes long periods during which the evidence is not being actively handled by anyone but is simply being stored in an evidence locker, typically having been placed in a sealed container carrying initials and dates that are intended to show that no tampering took place during storage.

It will be appreciated that when the sufficiency of the chain of custody is put into question, an able advocate may well be able to identify weaknesses in the chain, for example a failure to follow procedure or a lapse in record-keeping. It will also be appreciated that for an item of evidence to be authenticated in court, it may be necessary to bring as many as a dozen persons to the courtroom to testify as to their-role in the chain of custody. If any one of the persons is unavailable this may hinder the authentication.

In recent years the need for authentication has pertained not only to the above-mentioned categories of tangible evidence but has also extended to evidence of rather a less tangible nature, such as audio recordings. The earliest audio recordings were made on wire susceptible to magnetization, a recording medium that is physically bulky and was soon replaced with magnetic tape, a medium commonly used to this day. Audio recordings are also made by passing the audio through an analog-to-digital convertor and by storing digital data in a digital storage medium such as a magnetic hard disk, a semiconductor memory, or optical or magneto-optical storage such as a writable CD-ROM.

It will also be appreciated, however, that establishing the authenticity of an audio recording presents difficulties surpassing those associated with establishing the authenticity of tangible evidence. It is well known, even to persons having no technical training in the art, that analog recordings and digital data files are readily modified in ways that may, from a practical perspective, not be detectable afterwards. When the authenticity is put into question, it may be necessary to attempt to prove that the recording has not been tampered with or altered. This need may arise with financial transactions over the phone, conversations of prisoners while talking from prison, governmental wiretaps, and so on.

A proffer of evidence may also require establishing dates and times. Even if an item of evidence has been shown to be authentic, there may still remain a question exactly when it was collected. It may turn out to be important that the information contained in an audio recording was known chronologically prior to some other event, or that the recording was made on a particular date.

Some authentication schemes for audio recordings require storing and retrieving the information in some proprietary way. Such proprietary systems often have the drawback that the recording cannot be played back on conventional equipment but can only be played back on the proprietary equipment. In the case where the authenticity is to be established to the satisfaction of someone lacking technical training (e.g. some judges and some jurors), it may turn out to be difficult to explain the proprietary system satisfactorily. What's more, with some proprietary systems the very act of explaining the system in detail, to the extent needed to reach a conclusion of authenticity, may reveal the very information (e.g. a shared cryptographic key or a particular recording and playback technique) that would permit someone to generate tampered files that would appear to be authentic. At a trial or other courtroom proceeding, members of the public including the press may come into possession of the information presented to the judge and jury and with some proprietary systems this may compromise the system.

Public-key cryptography has been well-known for over two decades, and offers well-known approaches for signing, authentication, and encryption of digital files and permits establishing the non-repudiation status of signatures. Public-key cryptography has been used with great success in many fields including encryption of email and passing trusted messages between and among financial institutions. But no public-key cryptographic system has been devised for audio recordings that fully satisfies the many concerns addressed herein.

It would be desirable to have an authentication system for audio recordings which would permit explaining the system to show authenticity, whilst avoiding any revelation that would enable the generation of tampered files that appear to be authentic. It would be further desirable if this system could store the recordings digitally, thereby avoiding the need to store physically bulky analog recordings. It would be still further desirable if this system could store the digital recordings in a way that not only permitted authentication, but that also permitted playback on conventional (i.e. off-the-shelf) equipment without modification.

### SUMMARY OF INVENTION

A set of procedures is described which permit signing digital audio recordings by means of private keys, and which permit later authentication of such recordings, for example in a courtroom, in a way that is well suited to comprehension by non-technical personnel. Importantly, the explanation leading to such comprehension does not enable the creation of tampered recordings that would appear to be authentic. The procedures call for signing by trusted and disinterested third parties and for distributing hardware tokens storing various keys and key pairs. The format of the digital audio recordings permits playback on conventional equipment and also on equipment having cryptographic capabilities for authentication.

### BRIEF DESCRIPTION OF DRAWINGS

The invention will be described with respect to a drawing in several figures, of which

FIG. 1 shows information flow through a trusted third party and through an audio signer.

FIG. 2 shows information flow for an authentication process.

FIG. 3 shows hardware and information and physical flow from a manufacturing station through a certification authority to a customer.

FIGS. 4 and 5 show hardware and information flow from an archive location to an authenticating player location, assisted by a third party.

FIG. 6 shows process flow for a new system according to the invention.

FIG. 7 shows process flow for handling the expiration of a hardware security module.

FIG. 8 shows process flow for handling a faulty hardware security module.

FIG. 9 shows process flow for audio authentication according to the invention.

FIG. 10 shows a flowchart of steps followed with non-technical personnel to arrive at a finding as to authenticity.

Where possible, like reference designations have been used for like elements in the figures of the drawing.

### DETAILED DESCRIPTION

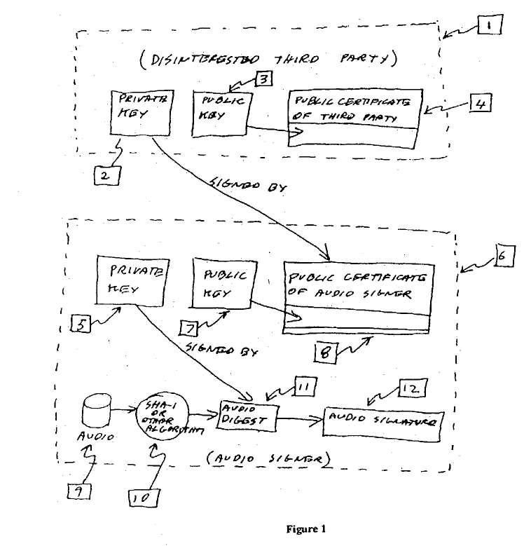

FIG. 1 shows information flow through a trusted third party and through an audio signer. In this embodiment of the invention, the audio signing system 6 may be part of an audio recording device or be a separate device whose sole purpose is to sign audio data. Preferably the signing takes place at the same time as the recording or integrally as part of the recording process. Alternatively the signing may take place nearly contemporaneously with the audio event of interest.

Audio data 9 is first processed into a digest 11 by an algorithm 10 such as SHA-1, MD5 or others. (The choice of a particular digest is not material to this discussion and those skilled in the art may readily select from among many well-known digests.) The audio digest 11 (sometimes called a hash) is then signed by a private key 5 using a signature algorithm such as RSA, DSA or others in order to produce an audio signature 12. (The choice of a particular signature algorithm is not material to this discussion and those skilled in the art may readily select from among many well-known signature algorithms.)

The system 6 uses a key pair comprising a private key 5 and an associated public key 7 which is used at a later time. Because the public key 7 is used at a later time to verify the signature of the audio, it must be available outside of the audio signing system 6. It may be “published” in any format, for example on a web site or a public key server. In the embodiment given here, the public key is specified as being in the standard X509 certificate format. This format is convenient because it provides for the ability to have the certificate 8 signed by a higher authority. Although there may be several levels of signatures (each level signing the one below it), in this example there is a “disinterested third party” or agency 1 that also has a key pair comprising private key 2 and public key 3. The agency's public key 3 is also published or distributed in some manner, in this case also an X509 certificate 4.

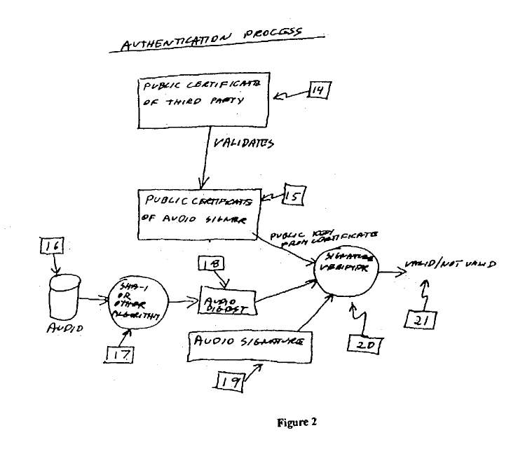

FIG. 2 shows information flow for an authentication process. In an exemplary implementation for the process of verifying the signature of the audio, if the signed audio had been modified in any way, the following authentication process will fail.

The audio 16 is first reduced to a digest 18 by the same algorithm 17 (10 in FIG. 1) that was used in the signing process of FIG. 1. This digest 18 as well as the signature 19 are verified to be valid or not valid based upon the public key (7 in FIG. 1) that is located in the public certificate 15 of the audio signer (6 in FIG. 1). At this point even if the verification result is “valid” there can still be doubt as to the validity of the audio signer's public certificate 15, thus, the public certificate 14 of the agency (1 in FIG. 1) is used to validate the authenticity of the audio signer's public certificate 15. This validation process leads to a verification 20 which yields an overall validation result 21.

As will be appreciated by those skilled in the art, for well-constructed key pairs, revelation of the public key does not reveal the private key. Generating a tampered file that appears to be authentic would require possession of the private key. Explaining the system to a judge or jury or other non-technical persons only requires disclosure of the algorithms generally and disclosure of the public keys, but does not require disclosure of the private keys. As a consequence, such explanation does not put the judge or jury or other non-technical persons (or the press or members of the general public attending the courtroom proceedings) into possession of information that compromises the system or enables persons to generate tampered files that appear to be authentic. The explanation, if carried out successfully, will nonetheless permit the judge or jury, and indeed members of the general public, to arrive at reliable and trustworthy conclusions as to the authenticity of the recorded audio. These highly desirable results are discussed in more detail below.

Such issues do not arise in the same way in most prior-art applications of public-key cryptography. For example when such cryptography or authentication is used to secure communications between an automated teller machine and a bank, the only persons who need to be convinced that the system is operating in a way that achieves its goals are technically trained persons such as bank employees and the manufacturers of the associated systems. Indeed the daily circumstance will be that no humans need to be convinced of anything, and it is simply that machines at two ends of a communications link need each to be convinced as to the authenticity and correctness of the communications.

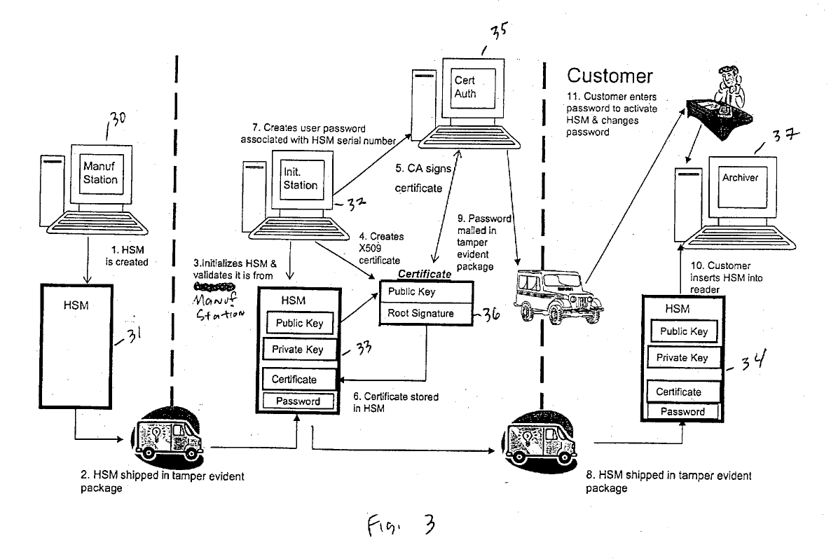

FIG. 3 shows hardware and information and physical flow from a manufacturing station through a certification authority to a customer. A manufacturing station 30 is used to create a hardware security module 31. A hardware security module 31 will contain storage for public and private keys. It will preferably contain dedicated hardware providing cryptographic engine functions, or in some cases may use a suitably programmed general-purpose processor to provide such functions. It is preferably designed in physical packaging that makes it exceedingly difficult, if not impossible, to open the packaging and to gain access to the stored data such as the private key or keys therein. Such modules may be custom-designed to provide optimal support for the aims of the invention, or may be selected from myriad standard commercial off-the-shelf hardware security modules intended to serve a variety of public-key cryptographic purposes. One suitable HSM is the Luna 2 HSM from Chrysalis-ITS of Ottawa, Canada. Those skilled in the art will have no difficulty selecting an appropriate module for the present invention.

The hardware security module (HSM) is shipped to an initialization station 32 in tamper-evident packaging. The initialization station 32 initializes the HSM 33 and validates that the HSM 33 did come from the expected manufacturing station 30, by inspection of the tamper-evident packaging and optionally by checking for stored data within the HSM 33 providing such validation. A key pair comprising a public key and a private key are created in the HSM 33 and stored there, and the public key is extracted. The public key is expressed in a certificate 36 which is signed by the certification authority 35. The signed certificate is stored in the HSM 33.

The HSM 33 has a unique internal serial number. The initialization station 32 creates a user password associated with the HSM serial number. The password is programmed into the HSM 33 so that persons not possessing the password are unable to gain access to functions of the HSM 33. The password is provided to a customer, preferably in a tamper-evident package.

The HSM 33 is shipped to the customer in a tamper-evident package. Most preferably the shipment of the HSM 33 is by means of a different delivery method than the provision of the password. At a minimum the two shipments are preferably done on different days and it is desirable that they be done by different carriers, in packages carrying no external markings that would prompt an observer to draw a connection between the packages.

The customer inserts the HSM 34 into a reader at an archiving station 37. The customer then enters the password, gains access to the HSM 34, and changes the password to one selected by the customer. The archiving station 37, sometimes called an “archiver,” is now available for archiving audio recordings.

It will be appreciated that nothing about the invention requires that the manufacturing station 30 be physically distant from the initialization station 32, thus requiring the tamper-evident shipping described above. For example the two stations could be physically adjacent in a single secure building, in which case there may be no need for tamper-evident shipping. Efficiency and economy of manufacture, however, will likely prompt establishment of a manufacturing station 30 that serves a variety of geographically diverse initialization stations for various purposes, in which case the tamper-evident shipping is desirable.

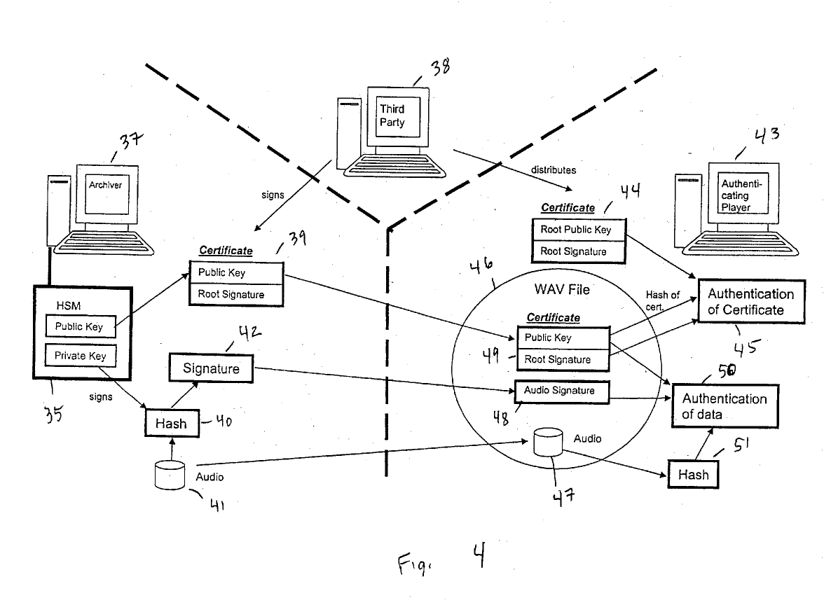

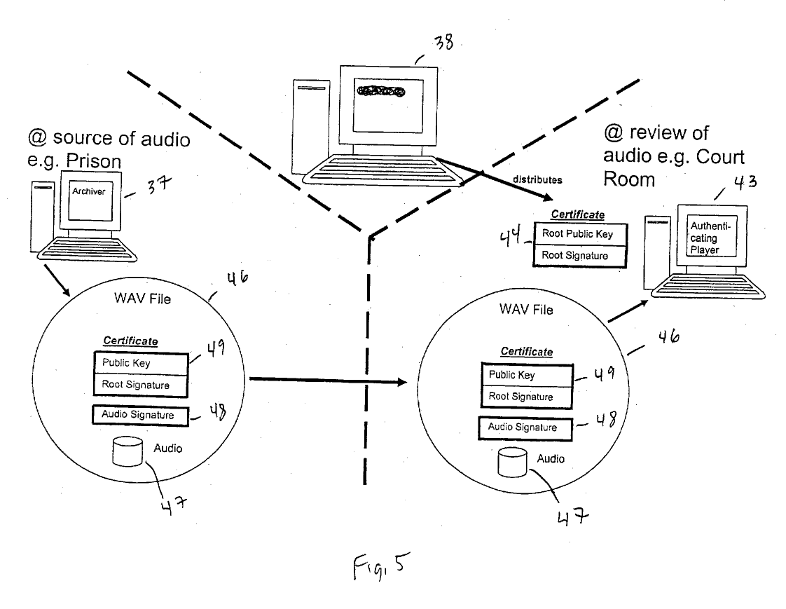

FIGS. 4 and 5 show hardware and information flow from an archive location to an authenticating player location, assisted by a third party.

Turning first to FIG. 4, what is shown is an archiving process in somewhat more detail than was previously discussed in connection with FIG. 1. The previously mentioned archiver 37 (previously mentioned in connection with FIG. 3) may be seen, equipped with an HSM 35 containing a public key and a private key comprising a key pair. In this example, an audio file 41 needs to be archived (corresponding to the audio file 9 in FIG. 1). A hash 40 is generated based upon the contents of the audio file (corresponding to algorithm 10 in FIG. 1). The hash 40 is signed by the private key of the HSM 35 (corresponding to private key 5 in FIG. 1). The result is a signature 42 (corresponding to audio signature 12 in FIG. 1).

FIG. 4 also shows a certificate 39 which contains the public key from the HSM 35. (This corresponds to the certificate 8 in FIG. 1 containing public key 7, signed by private key 2 of agency 1 in FIG. 1.) Nothing about the system requires that the signing of certificate 39 take place at the same time as the hashing 40 and signing 42, and indeed in the general case it is expected that the signing of certificate 39 need take place only once (when the key pair of HSM 35 is set up) while the hashing 40 and signing 42 will take place myriad times, once for each audio file 41 requiring archiving.

Also shown in FIG. 4 is the composite file 46 which contains the audio 47 (previously audio 41), the audio signature 48 (previously signature 42), and certificate 49 (previously certificate 39).

The composite file 46 contains these several elements as a matter of convenience since it contains nearly everything needed for the authentication that will follow. Those skilled in the art will appreciate that, although it is less desirable to do so, it would be possible to omit the certificate 49 and instead to provide merely a pointer to some external location where the certificate 49 is stored, in which case the party performing authentication would need to use the pointer to retrieve the certificate 49. Indeed, though there would be little reason to do so, the composite file 46 could also omit the audio signature 48 which could be stored elsewhere until needed. Those skilled in the art will appreciate, however, that for the authentication to succeed, the various “building blocks” that permit arriving at a conclusion as to authenticity must somehow be collected to perform the steps that are about to be described. The particular packaging of the building blocks may be varied to suit particular needs.

Returning to FIG. 4, what will now be described is an authentication process corresponding to that described in FIG. 2. The audio file 47 (corresponding to audio 16 in FIG. 2) is passed through a hash function to generate a hash output 51 (digest 18 in FIG. 2 being the output of 17 in FIG. 2). Importantly the hash function at 51 needs to be the same one used at 40, but this is not a problem since hash functions are conventional, easy to describe, and well understood, and if the would-be authenticator were to employ a hash function at 51 that did not match the hash function at 40 it would be immediately apparent since no files would ever authenticate. Even a single successful authentication permits confidence that the correct hash function is being used and this confidence applies to all later efforts to authenticate packages 46 from the particular archiver 37.

The signature 48 is decrypted by the public key in certificate 49 (15 in FIG. 2) and the result should match the hash output 51. If it does, then the data have been authenticated (subject to the question whether the certificate 49 is itself authentic). The third party 38, however, previously signed the certificate 49 (previously 39) with its private key. This permits the authenticating player 43 to use the public key of the third party 38, which is contained in the certificate 44. This public key is applied to the signature in the certificate 49. The result should match the public key in the certificate 49, and if it does, then the certificate 49 has been authenticated by the third party 38. Unless there is some reason to doubt the trustworthiness of the third party 38, the sequence of authentications will have authenticated the audio 47 (previously 41) and it may be played, for example to a judge or jury. In one embodiment of the invention, the player is unable to play the audio unless the authentication has succeeded, and in another embodiment, the player can play regardless of the outcome of the authentication, and an indication is given to the user as to whether the authentication succeeded or failed.

FIG. 5 shows the data flows of FIG. 4 but in a simplified fashion. The archiver 37 archives audio files, for example telephone calls to or from a prison. Each audio file 47 (typically encoded as a WAV file following well-known standards for digital storage of audio) is incorporated into a package 46 containing, as mentioned above in connection with FIG. 4, an audio signature 48 and a certificate 49. This is later transmitted to a courtroom where it is loaded into an authenticating player 43. A certificate 44 is received from third party 38. The certificate 44 and the package 46 permit reaching a conclusion as to authenticity of the audio file 47 and it is played on the player.

Those skilled in the art will immediately appreciate that while the sequence of events is described with respect to a single trusted third party 38, it may be convenient to have a chain of third parties, with the trusted party being at the “root” and intervening signers providing an unbroken chain of signatures down to the archiver 37 and to the authenticator 43. The selection of a single signer or a chain of signers is not material to the invention described here.

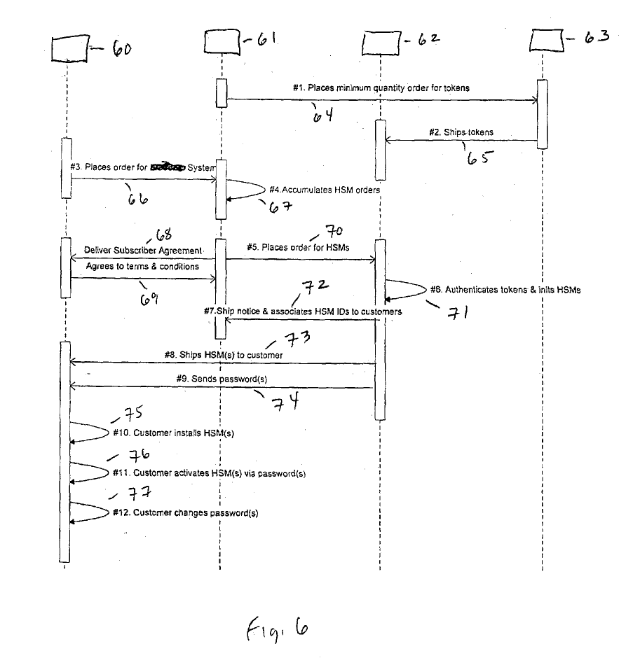

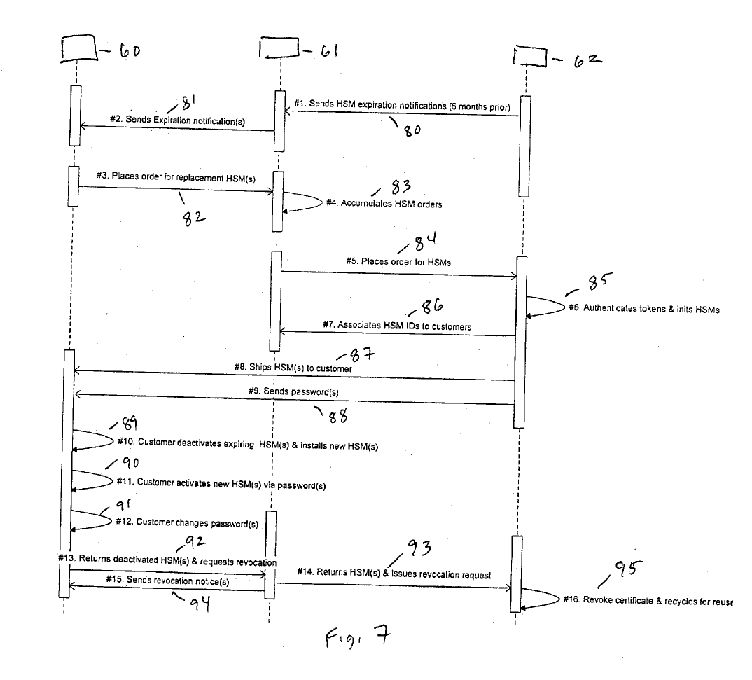

FIG. 6 shows process flow for setup of a new authentication system according to the invention. In FIG. 6 (and in FIGS. 7-9 below), customer 60 may for example be a governmental entity operating both a prison and a courthouse, and retailer 61 and initialization provider 62 may be seen, as well as HSM manufacturer 63. The retailer 61 places an order 64 for some minimum number of tokens (HSMs). The HSM manufacturer 63 manufactures and ships tokens 65 which are kept by the initialization provider 62 until needed. The customer 60 places an order 66 for an authentication system with the retailer 61. Orders are accumulated 67. The retailer 61 delivers a subscriber agreement 68 to the customer 60 who agrees with the terms and conditions 69. The retailer 61 then places an order 70 with the initialization provider 62 for HSMs. The initialization provider 62 initializes the tokens (HSMs) 71, associates particular HSM IDs with particular customers, and provides details 72 of same to the retailer 61. The initialization provider 62 ships 73 the HSMs to the customer 60 and, as discussed above in connection with FIG. 3, ships 74 corresponding passwords to the customer 60. The customer 60 installs 75 the HSMs, activates them 76 with the passwords, and changes 77 the passwords, all as previously described in connection with FIG. 3.

Those skilled in the art will appreciate that while the customer 60, initialization provider 62, HSM manufacturer 63, and retailer 61 are shown in FIGS. 6-9 as distinct entities, and while this arrangement is probably to be preferred, nothing about the invention requires that they be distinct. As one example the retailer 61 and initialization provider 62 could be one and the same without deviating from the invention. As another example the initialization provider 62 and HSM manufacturer 63 could be one and the same. Finally, a customer 60 such as a government entity might choose to perform some or all of the other three functions itself. It will be appreciated, of course, that the overall level of trust of the system may well be enhanced by having the initialization performed by a party who is distinct from the customer 60, that party preferably being a disinterested and trusted third party.

FIG. 7 shows process flow for handling the expiration of a hardware security module. Those skilled in the art are aware that any particular public/private key pair is preferably treated as having a particular life, and that the pair is preferably taken out of service on a time scale that is thought to be short when compared with an estimated time to obtain the private key based upon knowledge of the public key. Where an RSA public key is involved, for example, this time is estimated based on a guess as to the likely time required for factoring a large integer. To this end, each HSM is preferably put into service with a predetermined expiration date. Thus in FIG. 7 the initialization provider 62 may notify 80 the retailer 61 that an HSM has an imminent expiration date (e.g. six months away). The retailer 61 may then notify 81 the customer 60 of the imminent expiration. The customer 60 then places an order 82 for a replacement HSM. The retailer 61 accumulates 83 such orders and passes the order 84 to the initialization provider 62. The initialization provider 62 then initializes the tokens (HSMs) 85 (corresponding to 71 in FIG. 6), associates particular HSM IDs with particular customers, and provides details 86 (corresponding to 72 in FIG. 6) of same to the retailer 61. The initialization provider 62 ships 87 (corresponding to 73 in FIG. 6) the HSMs to the customer 60 and, as discussed above in connection with FIG. 3, ships 88 (corresponding to 74 in FIG. 6) corresponding passwords to the customer 60. The customer 60 removes the expiring HSMs 89 and installs new HSMs (corresponding to 75 in FIG. 6), activates them 90 (corresponding to 76 in FIG. 6) with the passwords, and changes 91 (corresponding to 77 in FIG. 1) the passwords, all as previously described in connection with FIG. 3. The customer 60 then returns 92 the old HSMs to the retailer 61 and requests revocation of the associated certificates. The retailer 61 returns 93 the expired HSMs to the initialization provider 62 and requests revocation of the associated certificates. The initialization provider 62 revokes 95 the certificates and recycles the HSMs for reuse. The retailer 61 sends revocation notices 94 to the customer 60.

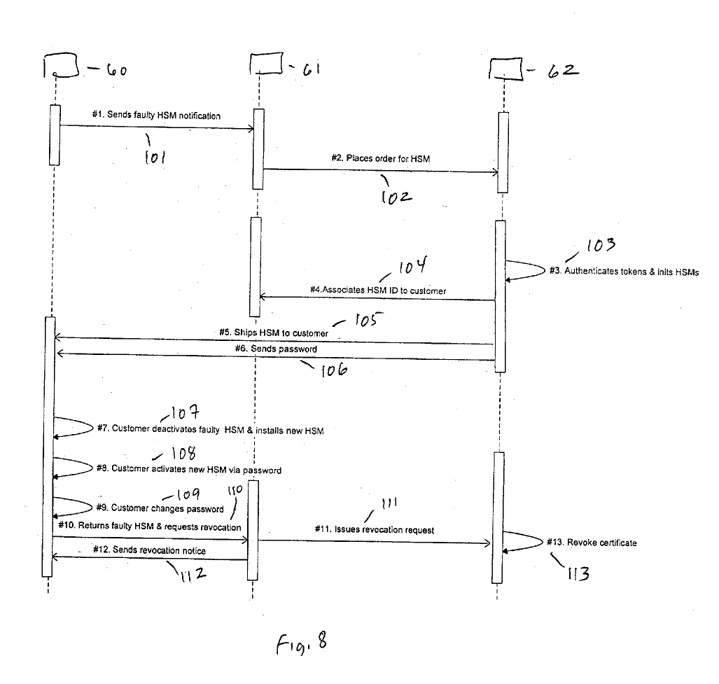

FIG. 8 shows process flow for handling a faulty hardware security module. No matter how reliable the HSMs are, it is important to provide for the possibility, however unlikely, that any particular HSM might fail prior to its expiration date. Thus in FIG. 8, the customer 60 may notify 101 the retailer 61 that an HSM has failed. The retailer 61 places an order 102 for a replacement HSM to the initialization provider 62. The initialization provider 62 then initializes the tokens (HSMs) 103, associates a particular HSM ID with the particular customer, and provides details 104 of same to the retailer 61. The initialization provider 62 ships 105 the HSM to the customer 60 and, as discussed above in connection with FIG. 3, ships 106 a corresponding password to the customer 60. The customer 60 removes the faulty HSM 107 and installs the replacement HSM, activates it 108 with the password, and changes 109 the password, all as previously described in connection with FIG. 3. The customer 60 then returns 110 the faulty HSM to the retailer 61 and requests revocation of the associated certificate. The retailer 61 returns 111 the faulty HSM to the initialization provider 62 and requests revocation of the associated certificate. The initialization provider 62 revokes 13 the certificate. The retailer 61 sends a revocation notice 112 to the customer 60.

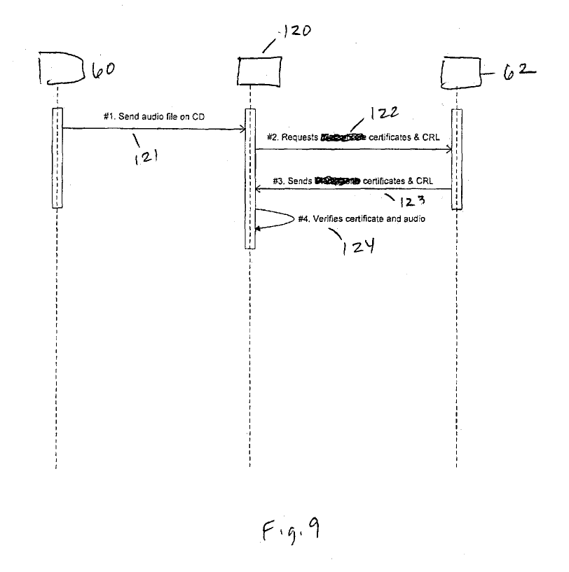

FIG. 9 shows process flow for audio authentication according to the invention. The customer 60 sends an audio file on a CD-ROM in step 121. The audio file is, for example, package 46 in FIGS. 4 and 5. The audio file is sent, for example, to a courthouse 120. The courthouse 120 obtains the signed certificate from the package 46 and determines who is the supposed signer. The courthouse, having identified the supposed signer, contacts that entity (initialization provider 62) to request that entity's public key and a certificate revocation list in step 122. At step 123 a response provides the certificate and the list. The courthouse then performs authentication in step 124, as described above in connection with FIG. 2.

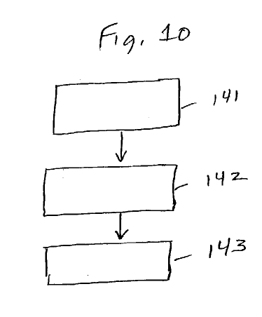

FIG. 10 shows a flowchart of steps followed with non-technical personnel to arrive at a finding as to authenticity. At step 141, the system of public and private keys is explained to the nonpersonnel, for example a judge and/or jury. This explanation may include a discussion of the mathematics of public and private keys as well as a discussion of the data flow and process steps described above. Hash algorithms may be discussed.

At 142, the judge and/or jury may follow the retrieval of the root public key from the signing authority and its use in authenticating the HSM certificate contained in the package 46, as well as the use of the public key in the HSM certificate to authenticate the hash signature of the audio file.

Finally at 143 the audio file may be played so that the judge and/or jury may hear what was originally recorded, for example a telephone call or other voice communications. This occurs under circumstances in which the judge and/or jury have reached their own conclusion as to the authenticity of the audio.

Stated differently, an embodiment of the invention may comprise an authentication method comprising the steps of making a digital audio recording of an event, yielding a first file, extracting a hash from the first file, cryptographically signing the hash using a first private key corresponding to a first public key, yielding a signature, cryptographically signing the first public key using a second private key corresponding to a second public key, yielding a certificate further comprising the first public key, communicating the first file, the signature, and the certificate to the at least one person, and communicating the second public key from a trusted source to the at least one person.

Next an explanation is provided to the at least one person of the extracting step, the first signing step, and the second signing step, and of the correspondence between the first private and public keys, and of the correspondence between the second private and public keys, the certificate is authenticated by means of the second public key, the authenticating performed in the presence of the at least one person, the signature is authenticated by means of the first public key from the certificate, the authenticating performed in the presence of the at least one person; and the audio recording is played in the presence of the at least one person.

In a typical situation the at least one person will be a person who has not previously been knowledgeable about the items being explained. For example this may be a juror who has not previously been exposed to public key cryptography and to hash functions.

It is instructive to discuss the internal structure of the package 46 in FIGS. 4 and 5. In a simple case the designer of the package 46 might devise a structure in which the only way to “play” the package 46 is through specialized software which would separate the audio information from the other items of data, and which would then play the audio data using a conventional player that can play WAV files. But in one embodiment of the invention, the structure of the package 46 may be devised so that the package may not only be played by the specialized authentication system but may also be played on a conventional player that can play WAV files. This is particularly helpful, for example, to persons who may wish to listen to the audio files prior to their use in court. Such persons (e.g. lawyers preparing for court) are typically interested simply in hearing the audio and are not, at such a moment, concerned about proving the authenticity of the audio. This permits copies of the package 46 (distributed, say, on CD-ROMs) to be listened to by persons who have ordinary personal computers, without the need to have an authenticating system.

Those skilled in the art are well aware of the internal format of conventional WAV files. A WAV file is made up of “chunks” such as RIFF chunks, Format chunks, Data chunks and other chunks.

The WAV file always starts with four bytes spelling the word “RIFF” in ASCII (American standard code for information interchange).

Next comes four bytes which give the total file-size (less eight bytes). Depending on the operating system and the particular player, if these four bytes express a size that is inconsistent with the file size reported by the operating system this may be an indication that the file has been corrupted. For this discussion the four bytes spelling the word “RIFF” and the four bytes giving the total file-size are collectively called the “RIFF chunk.” Next comes a portion of four bytes spelling “WAVE” in ASCII.

Next comes a format portion (or “chunk”) that begins with four bytes spelling “fmt” (note the trailing space) in ASCII, followed by four bytes setting forth the number of bytes in the “format” portion. This chunk continues with bytes that convey format information including a number of channels, a sampling frequency, a number of bytes per second, and a number of bits per sample.

Next comes a “data” chunk defined by four bytes spelling “data” in ASCII, and four bytes specifying the number of data bytes. These data bytes convey the audio information of the file.

The standard for WAV players requires that software can successfully read WAV files containing unknown chunks. Should an unknown chunk name be encountered, then the accompanying size field should be read, and the data bytes (the number of which is specified by the size field) should be skipped. This means that new chunks can be defined without breaking compatibility with legacy software. This aspect of the standard is relied upon to permit placing the signature and certificate information into the WAV file while preserving compatibility with conventional WAV players.

A conventional WAV player will read and interpret bytes from the start of the WAV file to the “data” bytes, and will then read and interpret the data bytes, the number of which is specified as described. If there are any more bytes in the WAV file after the specified number of data bytes have been interpreted, those additional bytes are ignored by the conventional WAV player and are significant only in the limited sense that they play a part in the total file size and thus should contribute to an actual file size that is consistent with the previously mentioned bytes that give the total file-size. Some WAV players will simply ignore the bytes after the audio data chunk, while others will attempt to read the signature and certificate chunks but will ignore them as soon as it is determined that the chunk name is not known to the player.

In one embodiment of the system according to the invention, the signing process involves the following steps:

1. A custom chunk containing Call Record information is added to the end of the file, that is, at a location that is after the audio data bytes.

2. Another custom chunk containing information about the algorithm used to create the signature as well as the time and date of the signing is added to the end of the file.

3. The archiving system then goes to the beginning of the file and indexes past the RIFF chunk.

4. The system then calculates the hash from the point just past the RIFF chunk to the end of the file. In doing so, it is calculating a hash based on the format chunk, the data chunk, and the two custom chunks just mentioned.

5. The system then signs the hash to create a signature.

6. The system then adds another custom chunk to the end of the file which contains the signature.

7. The system then adds another custom chunk (termed a certificate chunk) to the end of the file (now just after the signature chunk). This certificate chunk will contain the X509 certificate for the signing device, in this case the HSM of the archiving system.

8. The system then indexes to the beginning of the file and reads the RIFF chunk which contains the file size.

9. The system then updates the file size by adding the size of all the custom chunks that were added.

10. The system then writes an updated RIFF chunk back to the beginning of the WAV file.

What results from this procedure can be a digital audio file comprising first, second, and third portions, the first portion comprising format information, the second portion comprising audio data and means indicating the location of the end of the audio data, the third portion comprising a cryptographic signature of at least the second portion. In particular the cryptographic signature is preferably the result of a private key, the file further comprising a cryptographic certificate containing a public key corresponding to the private key. There may be an additional portion indicative of the length of the file. To save computational burden on the WAV player and on the authentication system it is desirable that the third portion follow the second portion rather than precede it.

In one embodiment, what is described is a method for use with a digital audio file comprising first and second portions, the first portion comprising format information, the second portion comprising audio data and means indicating the location of the end of the audio data, the method comprising the steps of calculating a hash based at least on the audio data, cryptographically signing the hash, yielding a signature; and adding a third portion to the file comprising the signature. The cryptographic signing may be performed with respect to a private key, the method further comprising the step of adding a fourth portion to the file comprising a cryptographic certificate comprising a public key corresponding to the private key. If the file further comprises information indicative of the length of the file, the method further will comprise the step of determining the new length of the file after addition of the additional portion or portions; and within the file, updating the information indicative of the length of the file based on the determined new length.

In the particular case of a WAV file, what results is a digital audio file having a length and a format, the file comprising four bytes spelling the word “RIFF” in ASCII, four bytes defining a first number indicative of the file length less 8, a number of bytes indicative of the format of the file, four bytes spelling the word “data” in ASCII, four bytes indicative of the length of the portion containing audio data bytes, the data bytes themselves, and a cryptographic signature calculated with respect to at least the first number of data bytes. The file may also contain, before or after the signature, a cryptographic certificate containing a public key corresponding to the private key that was used to calculate the signature.

The WAV file thus modified and signed (the package 46) will contain all the information that is needed by the authentication system to verify the authenticity of the file.

Advantageously, any “standard” WAV file player will still be able to play the WAV file in a normal fashion because the additional custom chunks will not be recognized by the player and will be ignored. In particular, the standard WAV player will reach the “data” chunk, will determine how many bytes of data exist, and will ignore any file contents after that number of bytes of data have been read.

Those skilled in the art will readily devise myriad obvious variations and improvements without departing from the invention, all of which are intended to fall within the claims that follow.

1. An authentication method comprising the steps of:
making a digital audio recording of an event, yielding a first file;
extracting a hash from the first file;
cryptographically signing the hash using a first private key corresponding to a first public key, yielding a signature;
cryptographically signing the first public key using a second private key corresponding to a second public key, yielding a certificate further comprising the first public key;
communicating the first file, the signature, and the certificate to at least one person;
communicating the second public key from a trusted source to the at least one person;
providing to the at least one person an explanation of the extracting step, the first signing step, and the second signing step, and of the correspondence between the first private and public keys, and of the correspondence between the second private and public keys;
authenticating the certificate by means of the second public key, the authenticating performed in the presence of the at least one person;
authenticating the signature by means of the first public key from the certificate, the authenticating performed in the presence of the at least one person; and
playing the audio recording in the presence of the at least one person.

2. The method of claim 1 wherein the making step, the extracting step, and the step of signing the hash are all performed at a first location that is out of the presence of the at least one person, and wherein the step of communicating the file, the signature, and the certificate to the at least one person is performed by communicating a single second file containing the first file, the signature, and the certificate.

3. The method of claim 1 wherein the at least one person has not previously been knowledgeable about public and private keys and about hashes.

4. The method of claim 1 wherein the step of cryptographically signing the first public key using a second private key is performed by the trusted source.

5. Audio file archival apparatus for use with an audio event of interest, the apparatus comprising:
an analog-to-digital converter responsive to the audio event for creating a first digital file indicative of the audio event;
means responsive to the first digital file for extracting a first hash therefrom;
secure means containing a first private key, responsive to the first hash for generating a signature; and
means communicating the first digital file and the signature external to the apparatus.

6. The apparatus of claim 5 wherein the communicating means communicates the first digital file and the signature together as a second file.

7. The apparatus of claim 6 wherein the second file further comprises a first public key corresponding to the first private key.

8. The apparatus of claim 7 wherein the second file further comprises a certificate authenticating the first public key.

9. Audio file authentication apparatus for use with a first digital file indicative of an audio event, and with a signature, and with a first public key, the apparatus comprising:
means authenticating the first public key;
means responsive to the first data file for extracting a second hash therefrom;
means responsive to the signature and the first public key for generating an output;
means comparing the output with the second hash;
means responsive to a successful comparison for annunciating the successful comparison; and
means responsive to the first digital file for playing back the audio event.

10. An audio file archival and authentication apparatus for use with an audio event of interest, the archival apparatus comprising:
an analog-to-digital converter responsive to the audio event for creating a first digital file indicative of the audio event;
means responsive to the first digital file for extracting a first hash therefrom;
secure means containing a first private key, responsive to the first hash for generating a signature; and
communicating the first digital file and the signature to the authentication apparatus;
the authentication apparatus comprising:
means authenticating a first public key corresponding to the first private key;
means responsive to the first data file for extracting a second hash therefrom;
means responsive to the signature and the first public key for generating an output;
means comparing the output with the second hash;
means responsive to a successful comparison for annunciating the successful comparison; and
means responsive to the first digital file for playing back the audio event.

11. A digital audio file comprising first, second, and third portions, the first portion comprising format information, the second portion comprising audio data and means indicating the location of the end of the audio data, the third portion comprising a cryptographic signature of at least the audio data.

12. The file of claim 11 wherein the cryptographic signature is the result of a private key, the file further comprising a cryptographic certificate containing a public key corresponding to the private key.

13. The file of claim 11 further comprising a portion indicative of the length of the file.

14. The file of claim 12 further comprising a portion indicative of the length of the file.

15. The file of claim 11 wherein the third portion follows the second portion.

16. A method for use with a digital audio file comprising first and second portions, the first portion comprising format information, the second portion comprising audio data and means indicating the location of the end of the audio data, the method comprising the steps of:
calculating a first hash based at least on the audio data;
cryptographically signing the first hash, yielding a signature; and
adding a third portion to the file comprising the signature.

17. The method of claim 16 further comprising the step of:
playing audio based upon the audio data.

18. The method of claim 16 further comprising the steps of:
reading the file and calculating a second hash based at least on the audio data;

19. The method of claim 16 wherein the cryptographic signing is performed with respect to a private key, the method further comprising the steps of:
reading the file and calculating a second hash based at least on the audio data;
applying a public key corresponding to the private key to the signature, and comparing the results to the second hash; and
in the event of a successful comparison, playing audio based on the audio data.

20. The method of claim 16 wherein the cryptographic signing is performed with respect to a private key, the method further comprising the step of:
adding a fourth portion to the file comprising a cryptographic certificate comprising a public key corresponding to the private key.

21. The method of claim 20 further comprising the steps of:
reading the file and calculating a second hash based at least on the audio data;
authenticating the public key by means of a third party;
applying the public key to the signature, and comparing the results to the second hash; and
in the event of a successful authentication and a successful comparison, playing audio based on the audio data.

22. The method of claim 16 wherein the file has a length, and wherein the file further comprises information indicative of the length of the file, the method further comprising the step of:
determining the new length of the file after addition of the third portion; and
within the file, updating the information indicative of the length of the file based on the determined new length.

23. The method of claim 17 wherein the file has a length, and wherein the file further comprises information indicative of the length of the file, the method further comprising the step of:
determining the new length of the file after addition of the third and fourth portions; and
within the file, updating the information indicative of the length of the file based on the determined new length.

24. The method of claim 16 wherein the third portion follows the second portion.

25. A digital audio file having a length and a format, the file comprising:
four bytes spelling the word “RIFF” in ASCII;
four bytes defining a first number;
a number of bytes indicative of the format of the file;
four bytes spelling the word “data” in ASCII;
four bytes defining a second number, the second number indicative of a number of audio data bytes;
the first number of audio data bytes;
a cryptographic signature calculated with respect to at least the first number of data bytes;
the first number selected to be indicative of the length of the file less eight bytes.

26. The file of claim 25 in which the cryptographic signature is calculated with respect to a private key, the file further comprising, after the first number of audio data bytes and before or after the cryptographic signature, a cryptographic certificate containing a public key corresponding to the private key.

27. The file of claim 25 in which the portions of which the file is comprised are in the sequence given.

28. A computer-readable storage medium comprising an digital audio file having a length and a format, the file comprising:
four bytes spelling the word “RIFF” in ASCII;
four bytes defining a first number;
a number of bytes indicative of the format of the file;
four bytes spelling the word “data” in ASCII;
four bytes defining a second number, the second number indicative of a number of audio data bytes;
first number of audio data bytes;
a cryptographic signature calculated with respect to at least the first number of data bytes;
the first number selected to be indicative of the length of the file less eight bytes

29. The storage medium of claim 28 in which the cryptographic signature is calculated with respect to a private key, the file further comprising, after the first number of audio data bytes and before or after the cryptographic signature, a cryptographic certificate containing a public key corresponding to the private key.

30. The storage medium of claim 28 in which the portions of which the file is comprised are in the sequence given.
